(19) United States
(12) Patent Application Publication
(10) Pub. No.: US 2024/0258925 A1
(43) Pub. Date: Aug. 1, 2024

(54) BOOST CONVERTER HAVING PEAK CURRENT LIMIT CONTROL CIRCUITRY RESPONSIVE TO FLYING CAPACITOR VOLTAGE FEEDBACK

(71) Applicant: TEXAS INSTRUMENTS INCORPORATED, Dallas, TX (US)

(72) Inventors: Yichao TANG, Santa Clara, CA (US); Jianbo GOU, Spring Valley, TX (US); Jiana LOU; Duo LI

(21) Appl. No.: 18/162,017

(22) Filed: Jan. 31, 2023

(51) Int. Cl. H02M 3/158; H02M 1/00; H02M 3/07; H02M 7/483

(52) U.S. Cl. CPC H02M 3/1582; H02M 1/0095; H02M 3/076; H02M 7/4837

(57) ABSTRACT

A boost converter control method includes: obtaining a peak current reference signal; obtaining a current sense signal; obtaining a flying capacitor (C_{FLY}) voltage error feedback signal; and providing switch control signals during a peak current limit mode responsive to the peak current reference signal, the current sense signal, and the C_{FLY} voltage error feedback signal.

### BACKGROUND

In modern portable electronic devices, the backlight module usually consumes the major portion of power dissipation. To power a backlight module, different direct-current-to-direct-current (DC-DC) converter topologies have been proposed. A three-level boost converter has been found to be an efficient driver for backlight light-emitting diodes (LEDs) and help extend the operation time of portable devices. Besides efficiency, overcurrent protection is important for system reliability and device safety. Accordingly, some converter topologies use a peak current limit, which is helpful for certain scenarios (e.g., during full-load startup and/or an overload condition for LED backlight drivers). A conventional 3-level boost converter uses current valley control to maintain a flying capacitor (C_{FLY}) voltage balance during normal operations. However, current valley control alone does not limit peak current cycle by cycle.

FIG. 1 is a block diagram showing a system 100 in accordance with a conventional approach. As shown, the system 100 includes LEDs 118 organized into LED strings 116A to 116N. The system 100 also includes a boost power stage 102 configured to regulate power to the LED strings 116A to 116N. The current for each of the LED strings 116A to 116N is controlled by respective current sinks 120A to 120N. As shown, the boost power stage 102 has a power input 104, a power output 112 and a ground terminal 114, and includes a 3-level boost converter topology. The 3-level boost converter topology includes a first low-side switch (LS1), a second low-side switch (LS2), a first high-side switch (HS1) and a second high-side switch (HS2). LS1 and LS2 are coupled in series between a switch (SW) node 106 and the ground terminal 114. Between the switch node 106 and the power input 104 is an inductor L. Between LS1 and LS2 is a low-side node 110. HS1 and HS2 are coupled in series between the switch node 106 and the power output 112. Between HS1 and HS2 is a high-side node 108. C_{FLY} is coupled between the high-side node 108 and the low-side node 110. The LEDs 118 of the system 100 may be part of a display (e.g., the display of a mobile device, the display of a vehicle, or another display).

The boost power stage 102 can be operated as either a 2-level converter or a 3-level converter. When operated as a 2-level converter, each switching cycle of the boost power stage 102 includes a high-side on phase (HS1 and HS2 on together, LS1 and LS2 off together) and low-side on phase (HS1 and HS2 off together, LS1 and LS2 on together). During each high-side phase (shown in the schematic diagram 430 of FIG. 4D), the voltage at the switch node 106 is the output voltage (V_{OUT}). During each low-side phase (shown in the schematic diagram 400 of FIG. 4A), the voltage at the switch node 106 is the ground voltage. When operated as a 3-level converter, each switching cycle of the boost power stage 102 may include the high-side on phase, the low-side on phase, a first intermediate phase (LS1 and HS2 on together, LS2 and HS1 off together), or a second intermediate phase (LS2 and HS1 on together, LS1 and HS2 off together). During the first intermediate phase (shown in the schematic diagram 410 of FIG. 4B), the voltage at the switch node 106 is V_{OUT}/2. During the second intermediate phase (shown in the schematic diagram 420 of FIG. 4C), the voltage at the switch node 106 is V_{OUT}/2.

FIGS. 2 and 3 are timing diagrams 200 and 300 showing signals and switch states related to the boost power stage 102 of FIG. 1 in accordance with a conventional approach. The signals of the timing diagrams 200 and 300 include an LS1 control signal (D₀), an LS2 control signal (D₁₈₀), an inductor current (I_{L}) related to inductor L, and the switch node voltage (V_{SW}). While not explicitly shown, the control signal for HS1 is the inverse of D₀ (i.e., D̅₀), and the control signal for HS2 is the inverse of D₁₈₀ (i.e., D̅₁₈₀).

In the timing diagram 200, the boost power stage 102 operates in a first low-side phase, the first intermediate phase, a second low-side phase, and the second intermediate phase. In the first low-side phase, V_{SW} is the ground voltage and I_{L} ramps up. In the first intermediate phase, V_{SW} is V_{OUT}/2, I_{L} ramps down, and C_{FLY} is charged to V_{OUT}/2. In the second low-side phase, V_{SW} is the ground voltage and I_{L} ramps up. In the second intermediate phase, V_{SW} is V_{OUT}/2, I_{L} ramps down, and C_{FLY} provides its charge to the power output 112.

In the timing diagram 300, the boost power stage 102 operates in the first intermediate phase, a first high-side phase, the second intermediate phase, and a second high-side phase. In the first intermediate phase, V_{SW} is V_{OUT}/2, I_{L} ramps up, and C_{FLY} is charged to V_{OUT}/2. In the first high-side phase, V_{SW} is V_{OUT} and I_{L} ramps down. In the second intermediate phase, V_{SW} is V_{OUT}/2, I_{L} ramps up, and C_{FLY} provides its charge to the power output 112. In the second high-side phase, V_{SW} is V_{OUT} and I_{L} ramps down.

Using 3-level control for the boost power stage 102 instead of 2-level control is preferred for an LED backlight scenario due to its higher efficiency, higher boost ratio, smaller solution size and better electromagnetic interference (EMI) performance. However, 3-level control does increase complexity of the controller. An ongoing challenge for 3-level control is the implementation of overcurrent protection while maintaining C_{FLY} balanced at V_{OUT}/2.

### SUMMARY

In an example embodiment, a boost converter control method comprises: obtaining a peak current reference signal; obtaining a current sense signal; obtaining a flying capacitor (C_{FLY}) voltage error feedback signal; and providing switch control signals during a peak current limit mode responsive to the peak current reference signal, the current sense signal, and the C_{FLY} voltage error feedback signal.

In another example embodiment, a boost converter controller comprises flying capacitor (C_{FLY}) voltage management circuitry having a first control output and first and second sense inputs. The C_{FLY} voltage management circuitry is configured to provide a C_{FLY} voltage error feedback signal at the first control output responsive to a positive terminal C_{FLY} voltage received at the first sense input and a negative terminal C_{FLY} voltage at the second sense input. The boost converter controller also comprises multi-mode control circuitry having a first control input, a second control input, a third control input, a second control output, a third control output, a fourth control output, and a fifth control output, and the first control input coupled to the first control output. The multi-mode control circuitry is configured to: receive the C_{FLY} voltage error feedback signal at the first control input; receive a current sense signal at the second control input; receive a peak current reference signal at the third control input; and in a peak current limit mode, provide switch control signals at the second control output, the third control output, the fourth control output, and the fifth control output responsive to the peak current reference signal, the current sense signal, and the C_{FLY} voltage error feedback signal.

In yet another example embodiment, a system comprises a multi-level boost converter power stage configured to provide an output voltage responsive to an input voltage, a flying capacitor (C_{FLY}) voltage level, and operation of a set of switches. The system also comprises a controller coupled to the multi-level boost converter power stage and configured to operate the set of switches using a multi-level valley mode and a peak current limit mode. The peak current limit mode is responsive to a peak current reference signal, a current sense signal, a current slope signal, and a C_{FLY} voltage error feedback signal.

### BRIEF DESCRIPTION OF THE DRAWINGS

FIG. 1 is a block diagram showing a system in accordance with a conventional approach.

FIGS. 2 and 3 are timing diagrams showing signals and switch states related to the boost power stage of FIG. 1 in accordance with a conventional approach.

FIGS. 4A-4D are schematic diagrams showing phases of the boost power stage of FIG. 1 in accordance with a conventional approach.

FIG. 5 is a schematic diagram showing a system having a controller in accordance with an example embodiment.

FIGS. 6A to 6C is a schematic diagram showing a controller and related power stage components in accordance with an example embodiment.

FIG. 7 is a schematic diagram showing a slope compensation circuit and peak current limit control circuitry in accordance with an example embodiment.

FIG. 8 is a timing diagram showing signals and control states for a boost power stage based on the peak current limit control circuitry of FIG. 7.

FIG. 9 is a schematic diagram showing a slope compensation circuit and peak current limit control circuitry in accordance with another example embodiment.

FIG. 10 is a timing diagram showing signals and control states for a boost power stage based on the peak current limit control circuitry of FIG. 9.

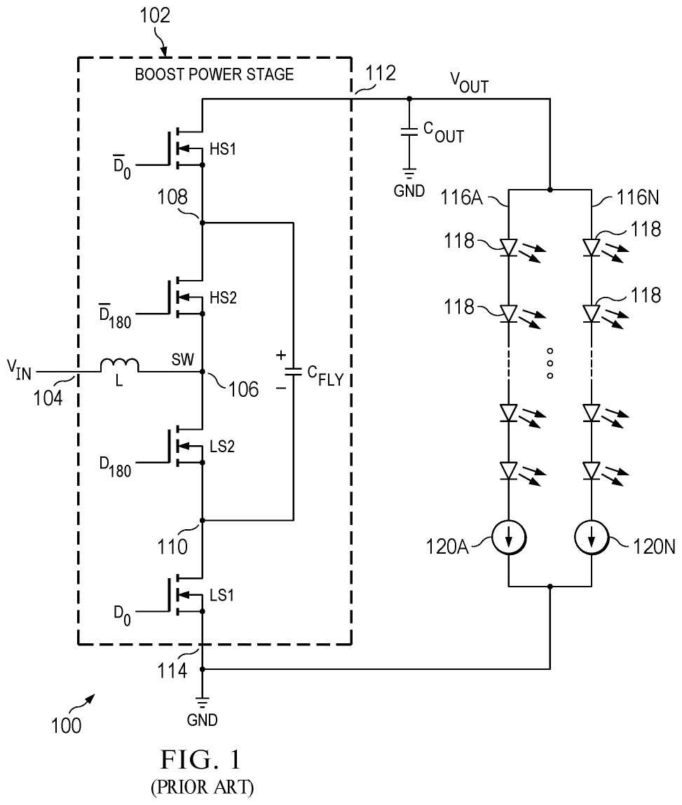

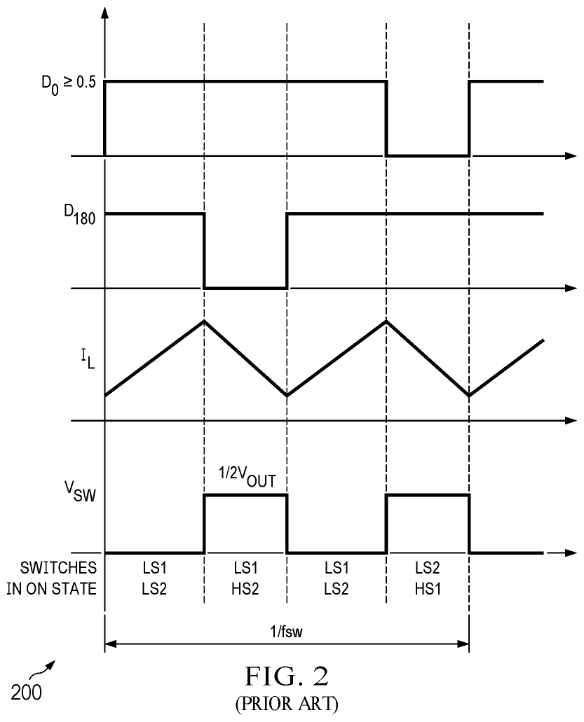

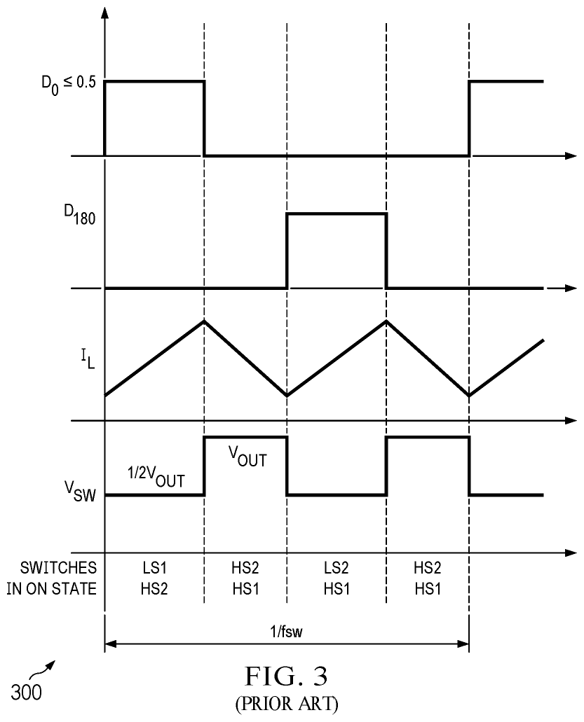

### DETAILED DESCRIPTION

The same reference numbers or other reference designators are used in the drawings to designate the same or similar (either by function and/or structure) features.

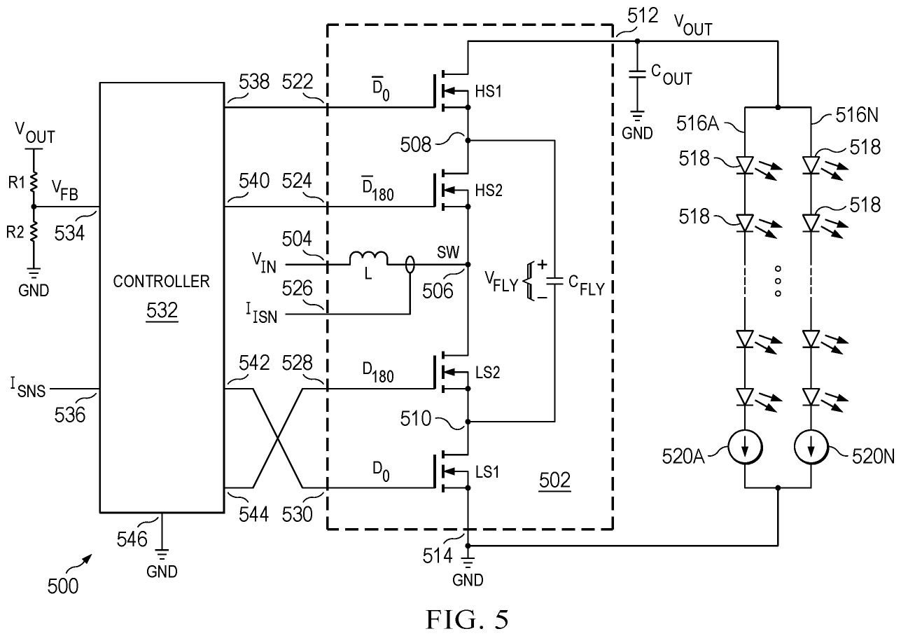

FIG. 5 is a schematic diagram showing a system 500 having a controller 532 in accordance with an example embodiment. Without limitation, the controller 532 may include flying capacitor (C_{FLY}) voltage management circuitry, multi-mode control circuitry, and driver circuitry. In some examples, the C_{FLY} voltage (V_{CFLY}) management circuitry includes a differential voltage sense circuit and a V_{CFLY} error feedback circuit. In some examples, the multi-mode control circuitry includes a voltage loop compensation circuit, slope compensation circuitry, valley current sense circuitry, peak current sense circuitry, and peak current limit control circuitry. In different examples, the peak current limit control circuitry may have a constant frequency topology or a varied frequency topology.

As shown, the system 500 includes light-emitting diodes (LEDs) 518 organized into LED strings 516A to 516N. The system 500 also includes a boost power stage 502 configured to regulate power to the LED strings 516A to 516N. The current for each of the LED strings 516A to 516N is controlled by respective current sinks 520A to 520N. As shown, the boost power stage 502 has a power input 504, a power output 512 and a ground terminal 514, and includes a 3-level boost converter topology. The boost power stage 502 also has a first control input 522, a second control input 524, a sense output 526, a third control input 528, and a fourth control input 530.

In the example of FIG. 5, the 3-level boost converter topology of the boost power stage 502 includes first low-side switch (LS1), a second low-side switch (LS2), a first high-side switch (HS1) and a second high-side switch (HS2). LS1 and LS2 are coupled in series between a switch (SW) node 506 and the ground terminal 514. Between the switch node 506 and the power input 504 in an inductor L. Between LS1 and LS2 is a low-side node 510. HS1 and HS2 are coupled in series between the switch node 506 and the power output 512. Between HS1 and HS2 is a high-side node 508. A flying capacitor (C_{FLY}) is coupled between the high-side node 508 and the low-side node 510. The LEDs 518 of the system 500 may be part of a display (e.g., the display of a mobile device, the display of a vehicle, or another display).

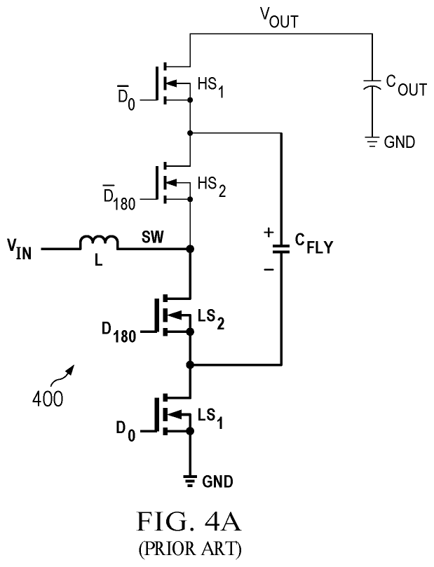

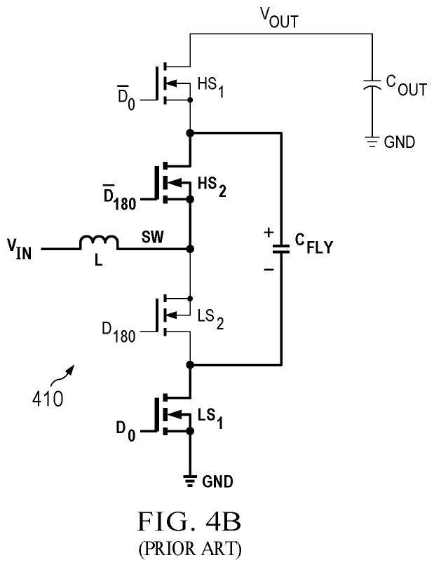

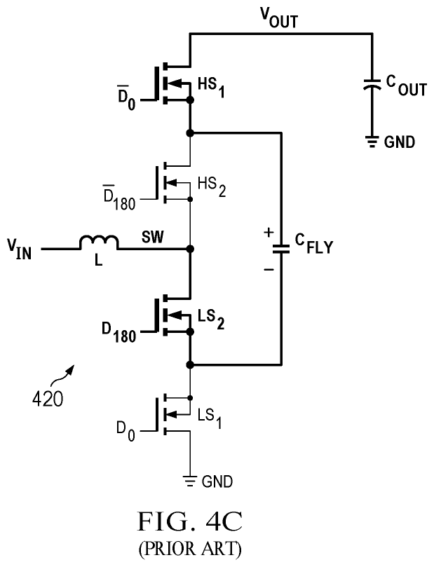

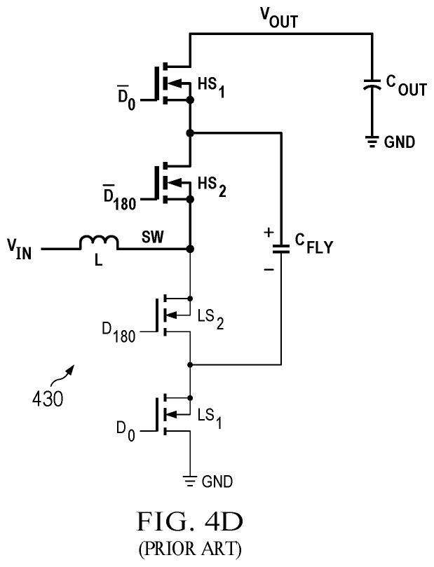

The boost power stage 502 can be operated as either a 2-level converter or a 3-level converter. When operated as a 2-level converter, each switching cycle of the boost power stage 502 includes a high-side on phase (HS1 and HS2 on together, LS1 and LS2 off together) and low-side on phase (HS1 and HS2 off together, LS1 and LS2 on together). During each high-side phase (shown in FIG. 4D), the voltage at the switch node 506 is V_{OUT}. During each low-side phase (shown in FIG. 4A), the voltage at the switch node 506 is the ground voltage. When operated as a 3-level converter, each switching cycle of the boost power stage 502 may include the high-side on phase, the low-side on phase, a first intermediate phase (LS1 and HS2 on together, LS2 and HS1 off together), or a second intermediate phase (LS2 and HS1 on together, LS1 and HS2 off together). During the first intermediate phase (shown in FIG. 4B), the voltage at the switch node 506 is V_{OUT}/2. During the second intermediate phase (shown in FIG. 4C), the voltage at the switch node 506 is V_{OUT}/2.

In operation, the boost power stage 502 is configured to: receive an input voltage (V_{IN}) at the power input 504; receive an HS1 drive signal (D̅₀) at the first control input 522; receive an HS2 drive signal D̅₁₈₀( ) at the second control input 524; receive an LS2 drive signal (D₁₈₀) at the third control input 528; receive an LS1 drive signal (D₀) at the fourth control input 530; provide a switch node sense current (I_{SNS}) at the sense output 526 responsive to V_{IN}, HS1_ON, HS2_ON, LS1_ON, and LS2_ON; and provide V_{OUT} at the power output 512 responsive to V_{IN}, D̅₀, D̅₁₈₀, D₁₈₀, and D₀. In different scenarios, the boost power stage 502 may be operated using 2-level control or 3-level control.

In the example of FIG. 5, the controller 532 is configured to provide D̅₀, D̅₁₈₀, D₁₈₀, and D₀. In some example embodiments, the controller 532 has a control input 534, a sense input 536, a first control output 538, a second control output 540, a third control output 542, a fourth control output 544, and a ground terminal 546. In some example embodiments, the controller 532 includes: C_{FLY} voltage (V_{CFLY}) management circuitry; multi-mode control circuitry; and driver circuitry. Together the V_{CFLY} management circuitry, the multi-mode control circuitry, and the driver circuitry may be referred to herein as controller circuitry. In some example embodiments, the V_{CFLY} management circuitry includes: a differential voltage sense circuit; and a V_{CFLY} error feedback circuit. The multi-mode control circuitry includes: voltage loop compensation circuitry; slope compensation circuitry; valley current sense circuitry; peak current sense circuitry; and peak current limit control circuitry. In some example embodiments, the peak current limit control circuitry is based on a constant-frequency control topology. In other example embodiments, the peak current limit control circuitry is based on a varied-frequency control topology.

In operation, the controller 532 is configured to receive a feedback voltage (V_{FB}) at the control input 534. In the example of FIG. 5, V_{FB} is a scaled version of V_{OUT} based on the values of voltage divider resistors R1 and R2. The controller 532 is also configured to: receive ISNS at the sense input 536; provide D̅₀ at the first control output 538 responsive to V_{FB}, I_{SNS}, and the operations of the controller circuitry; provide D̅₁₈₀ at the second control output 540 responsive to V_{FB}, I_{SNS}, and the operations of the controller circuitry; provide D₁₈₀ at the third control output 542 responsive to V_{FB}, I_{SNS}, and the operations of the controller circuitry; provide D₀ at the fourth control output 544 responsive to V_{FB}, I_{SNS}, and the operations of the controller circuitry. Without limitation, the controller 532 is configured to provide D̅₀, D̅₁₈₀, D₁₈₀, and D₀ to the boost power stage 502 using 3-level control or 2-level control with overcurrent protection while maintaining C_{FLY} balanced at V_{OUT}/2.

In some example embodiments, the controller 532 is configured to perform peak current limit control operations with V_{CFLY} feedback in the control loop to ensure I_{L} is limited to a target peak current limit while maintaining V_{CFLY} within a target range (approximately V_{OUT}/2) to maintain voltage balance. During normal control operations (when I_{L} does not reach the target peak current limit), the controller 532 may use 3-level control operations based on current valley control, which inherently regulates V_{CFLY} to the target range. During peak current limit control operations (e.g., triggered when I_{L} reaches the target peak current limit), the controller 532 transitions to peak current limit control operations that limit I_{L} based on the target current peak limit while regulating V_{CFLY} to the target range. In different example embodiments, the controller 532 is configured to provide peak current limit control operations based on a constant-frequency control topology or a varied-frequency control topology.

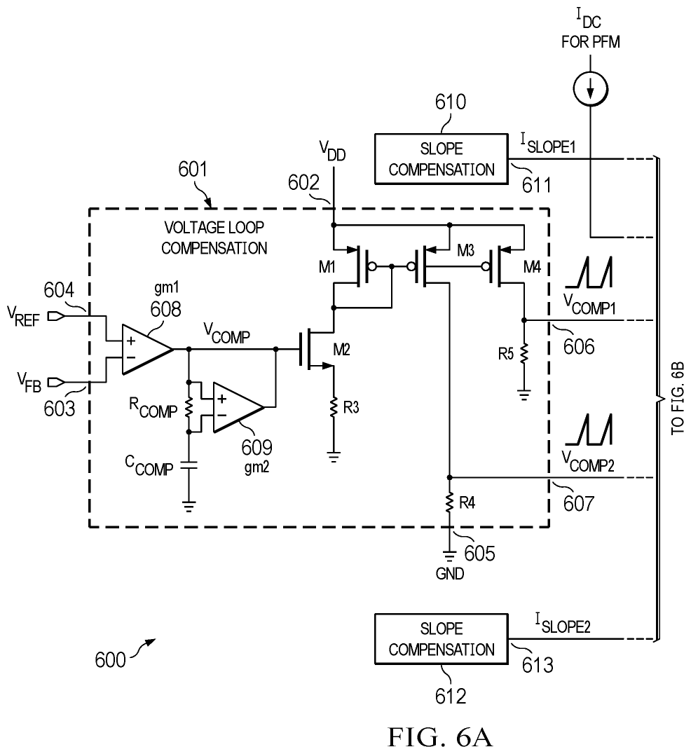

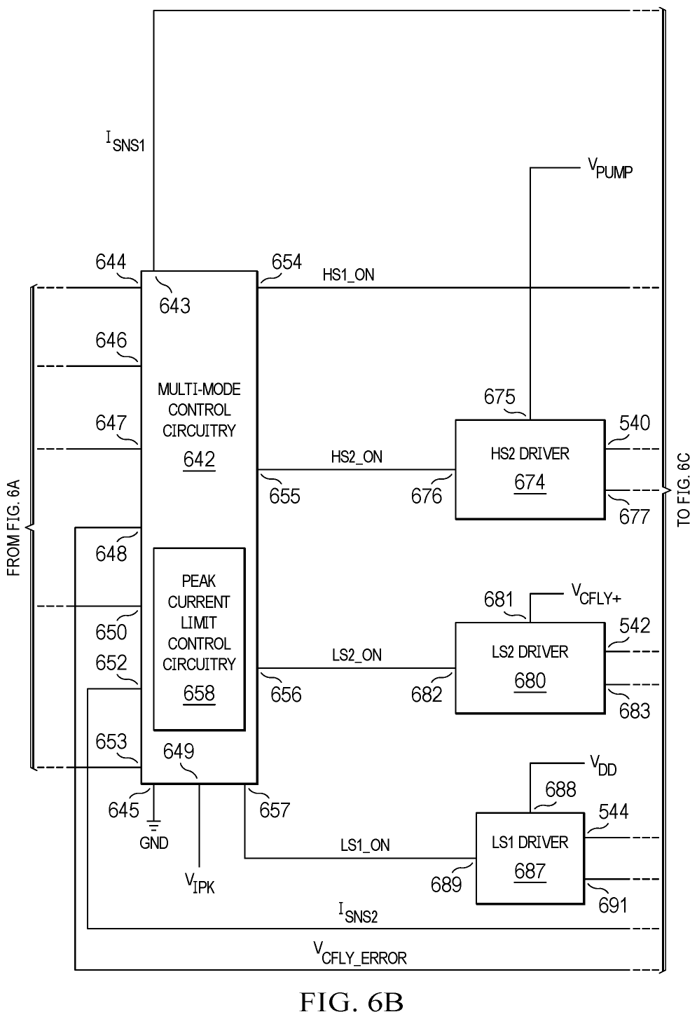

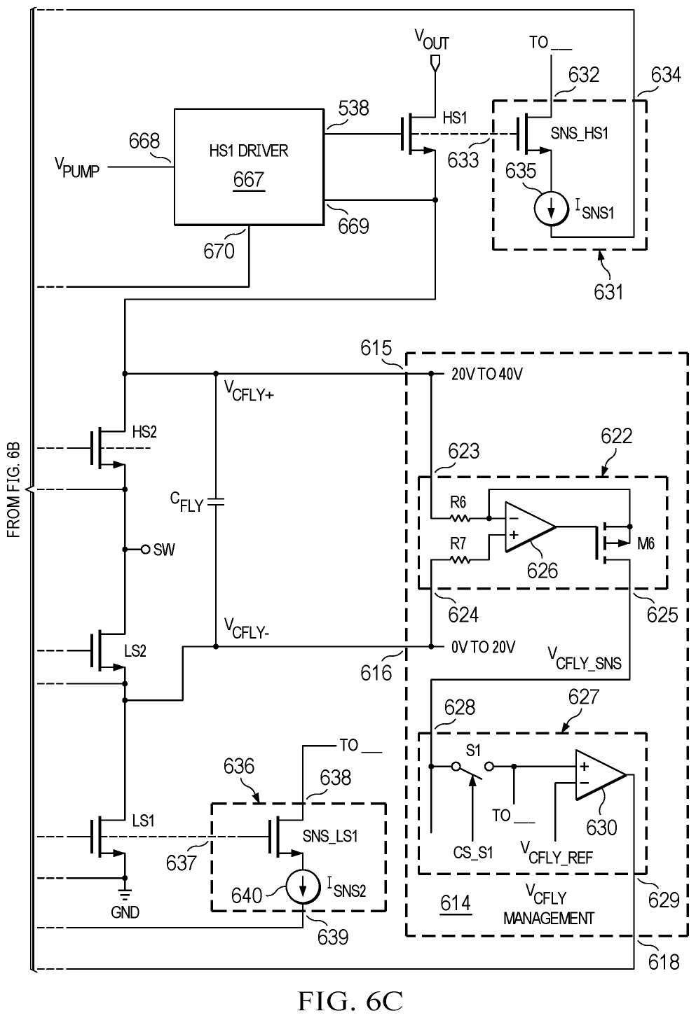

FIGS. 6A to 6C is a schematic diagram showing a controller 600 (an example of the controller 532 in FIG. 5) and related power stage components (HS1, HS2, LS2, LS1, and C_{FLY} in the arrangement shown) in accordance with an example embodiment. In some example embodiments, the controller 600 includes V_{CFLY} management circuitry 614; and driver circuitry (e.g., the HS1 driver circuit 667, the HS driver circuit 674, the LS2 driver circuit 680, and the LS1 driver circuit 687). The controller 600 also includes peak and valley current control circuitry such as voltage loop compensation circuitry 601, a first slope compensation circuit 610, a second slope compensation circuit 612, and multi-mode control circuitry 642. As shown, the controller 600 includes transistors M1 to M12. Each of M1 to M12 has a first current terminal, a second current terminal, and a control terminal.

In some example embodiments, the V_{CFLY} management circuitry 614 has a first sense input 615, a second sense input 616, and a control output 618. As shown, the V_{CFLY} management circuitry 614 includes: a differential voltage sense circuit 622; and a V_{CFLY} error feedback circuit 627. The differential voltage sense circuit 622 has a first sense input 623, a second sense input 624, and a sense output 625. The first sense input 623 of the differential voltage sense circuit 622 is coupled to the first sense input 615 of the V_{CFLY} management circuitry 614. The second sense input 624 of the differential voltage sense circuit 622 is coupled to the second sense input 616 of the V_{CFLY} management circuitry 614. As shown, the differential voltage sense circuit 622 includes a comparator 626, resistors R6 and R7, and transistor M6. The comparator 626 has an inverting (“−”) input, a non-inverting (“+”) input, and a comparator output. The inverting (“−”) input of the comparator 626 is coupled to the first sense input 623 via R6. The inverting (“−”) input of the comparator 626 is also coupled to the first current terminal of M6. The non-inverting (“+”) input of the comparator 626 is coupled to the second sense input 624 via R7. The comparator output of the comparator 626 is coupled to the control terminal of M6. The second current terminal of M6 is coupled to the sense output 625.

The V_{CFLY} error feedback circuit 627 has a feedback input 628 and a V_{CFLY} error output 629. The feedback input 628 of the V_{CFLY} error feedback circuit 627 is coupled to the sense output 625 of the differential voltage sense circuit 622. The V_{CFLY} error output 629 of the V_{CFLY} error feedback circuit 627 is coupled to the control output 618 of the V_{CFLY} management circuit 614. In some example embodiments, the V_{CFLY} error feedback circuit 627 includes a switch S1 and a comparator 630. The comparator 630 has an inverting (“−”) input, a non-inverting (“+”) input, and a comparator output. The non-inverting (“+”) input of the comparator 630 is coupled to the feedback input 628 via S1. More specifically, a first side of S1 is coupled to the feedback input 628, and a second side of S1 is coupled to the non-inverting (“+”) input of the comparator 630. S1 is controlled by a control signal (CS_S1), which enables the operation of the comparator 630. The inverting (“−”) input of the comparator 630 is coupled to a reference voltage source (not shown) and receive a V_{CFLY} reference voltage (V_{CFLY_REF}). The comparator output of the comparator 630 is coupled to the V_{CFLY} error output 629.

In operation, the differential voltage sense circuit 622 is configured to: receive V_{CFLY+} at the first sense input 623; receive V_{CFLY-} at the second sense input 624; and provide a V_{CFLY} sense signal (V_{CFLY_SNS}) at the sense output 625 responsive to V_{CFLY+}, V_{CFLY-}, and the operations of the comparator 626 and M6. In operation, the V_{CFLY} error feedback circuit 627 is configured to receive V_{CFLY_SNS} at the feedback input 628 and provide V_{CFLY_ERROR} at the V_{CFLY} error output 629 responsive to V_{CFLY_SNS}, V_{CFLY_REF}, and the operations of S1 and comparator 630.

The peak and valley current control circuitry of the controller 600 includes: voltage loop compensation circuitry 601 (see FIG. 6A); a first slope compensation circuit 610 (see FIG. 6A); a second slope compensation circuit 612 (see FIG. 6A); a valley current sense circuit 631 (see FIG. 6C); a peak current sense circuit 636 (see FIG. 6C); and multi-mode control circuitry 642 (see FIG. 6B). In the example of FIGS. 6A to 6C, the first slope compensation circuit 610 includes a slope compensation output 611, and the second slope compensation circuit 612 includes a slope compensation output 613. In operation, the first slope compensation circuit 610 is configured to provide a first slope current (I_{SLOPE1}) at the slope compensation output 611. The second slope compensation circuit 612 is configured to provide a second slope current (I_{SLOPE2}) at the slope compensation output 613.

In the example of FIGS. 6A to 6C, the voltage loop compensation circuitry 601 has a power input 602, a first control input 603, a second control input 604, a ground terminal 605, a first voltage compensation output 606, and a second voltage compensation output 607. The voltage loop compensation circuitry 601 includes a first comparator 608, a second comparator 609, transistors M1 to M4, a capacitor C_{COMP}, and resistors R_{COMP}, R₃, R₄, and R₅ in the arrangement shown. As shown, each of the first comparator 608 and the second comparator 609 has a respective inverting (“−”) input, a respective non-inverting (“+”) input, and a respective comparator output. The non-inverting (“+”) input of the first comparator 608 is coupled to the second control input 604. The inverting (“−”) input of the first comparator 608 is coupled to the first control input 603. The comparator output of the first comparator 608 is coupled to the control terminal of M2, the non-inverting (“+”) input of the second comparator 609, the comparator output of the second comparator 609, and a first side of R_{COMP}. The second side of R_{COMP} is coupled to the inverting (“−”) input of the first comparator 608 and to a first side of C_{COMP}. The second side of C_{COMP} is coupled to the ground terminal 605.

Each of the first current terminals of M1, M3, and M4 is coupled to the power input 602. The second current terminal of M1 is coupled to the first current terminal of M2 and to the control terminals of M1, M3, and M4. The second current terminal of M2 is coupled to a first side of R3. The second side of R3 is coupled to the ground terminal 605. The second side of M3 is coupled to a first side of R4 and the second voltage compensation output 607. The second side of R4 is coupled to the ground terminal 605. The second current terminal of M4 is coupled to a first side of R5 and the first voltage compensation output 606.

In operation, the voltage loop compensation circuitry 601 is configured to: receive V_{FB} at the first control input 603; receive a reference voltage (V_{REF}) at the second control input 604; receive a power supply voltage (V_{DD}) at the power input 602; provide a first voltage compensation signal (V_{COMP1}) at the first voltage compensation output 606 responsive to V_{FB} and V_{REF}, and the operations of the first comparator 608, the second comparator, and M1, M2, and M4; and provide a second voltage compensation signal (V_{COMP2}) at the second voltage compensation output 607 responsive to V_{FB} and V_{REF}, and the operations of the first comparator 608, the second comparator, and M1, M2, and M3.

The valley current sense circuit 631 has a current input 632, a control input 633, and a sense current output 634. As shown, the valley current sense circuit 631 includes a transistor SNS_HS1 and a current source 635 in the arrangement shown. The first current terminal of SNS_HS1 is coupled to the current input 632. The second current terminal of SNS_HS1 is coupled a first side of the current source 635. The second side of the current source 635 is coupled to the sense current output 634. The control terminal of SNS_HS1 is coupled to the control input 633. In operation, the valley current sense circuit 631 is configured to provide a current sense signal (I_{SNS1}) at the sense current output 634 responsive to the operations of SNS_HS1 and the current source 635 (I_{SNS1} tracks the current through HS1 and can be used to detect when the current through HS1 reaches a valley threshold).

The peak current sense circuit 636 has a control input 637, a current input 638, and a sense current output 639. As shown, the peak current sense circuit 636 includes a transistor SNS_LS1 and a current source 640 in the arrangement shown. The first current terminal of SNS_LS1 is coupled to the current input 638. The second current terminal of SNS_LS1 is coupled a first side of the current source 640. The second side of the current source 640 is coupled to the sense current output 639. The control terminal of SNS_LS1 is coupled to the control input 637. In operation, the peak current sense circuit 636 is configured to provide a current sense signal (I_{SNS2}) at the sense current output 639 responsive to the operations of SNS_LS1 and the current source 640 (I_{SNS2} tracks the current through LS1 and can be used to detect when the current through LS1 reaches a valley threshold).

In the example of FIGS. 6A to 6C, the multi-mode control circuitry 642 has a first control input 643, a second control input 644, a ground terminal 645, a third control input 646, a fourth control input 647, a fifth control input 648, a sixth control input 649, a seventh control input 650, an eighth control input 652, a ninth control input 653, a first control output 654, a second control output 655, a third control output 656, a fourth control output 657. In some example embodiments, the multi-mode control circuitry 642 in the example of FIGS. 6A to 6C includes peak current limit control circuitry 658.

In operation, the multi-mode control circuitry 642 is configured to: receive I_{SNS1} at the first control input 643; receive I_{SLOPE1} at the second control input 644; receive a bias current (I_{DC}) (e.g., used to generate an offset voltage to avoid negative voltage in circuitry) at the third control input 646; receive V_{COMP1} at the fourth control input 647; receive V_{CFLY_ERROR} at the fifth control input 648; receive a peak current reference (V_{IPK}) at the sixth control input 649; receive V_{COMP2} at the seventh control input 650, receive I_{SNS2} at the eighth control input 652; receive I_{SLOPE2} at the ninth control input 653; provide HS1_ON at the first control output 654 responsive to I_{SNS1}, I_{DC}, V_{COMP1}, V_{IPK}, V_{CFLY_ERROR}, V_{COMP2}, and I_{SNS2}; provide HS2_ON at the second control output 655 responsive to I_{SNS1}, I_{DC}, V_{COMP1}, V_{IPK}, V_{CFLY_ERROR}, V_{COMP2}, and I_{SNS2}; provide LS2_ON at the third control output 656 responsive to I_{SNS1}, I_{DC}, V_{COMP1}, V_{IPK}, V_{CFLY_ERROR}, V_{COMP2}, I_{SNS2}, and I_{SLOPE2}; and provide LS1_ON at the fourth control output 657 responsive to I_{SNS1}, I_{SLOPE1}, I_{DC}, V_{COMP1}, V_{IPK}, V_{CFLY_ERROR}, V_{COMP2}, and I_{SNS2}. With the peak current limit control circuitry 658, multi-mode control circuitry 642 is configured to support peak current limit control operations that provide overcurrent protection for boost power stage components (e.g., LS1, LS2, HS1, HS2) while maintaining C_{FLY} balanced at V_{OUT}/2.

In some example embodiments, the peak current limit control circuitry 658 is configured to perform current peak limit control operations responsive to V_{CFLY} error feedback. The current peak limit control operations ensure I_{L} is limited based on a target peak current while maintaining V_{CFLY} within a target range (approximately V_{OUT}/2) to maintain voltage balance. In different example embodiments, the peak current limit control circuitry 658 may have a constant-frequency control topology or a varied-frequency control topology. Besides performing peak current limit control operations, the multi-mode control circuitry 642 may be configured to perform 3-level control operations based on current valley control when I_{L} does not reach a peak current level (e.g., during normal operations). The 3-level control operations inherently regulate V_{CFLY} to the target range.

In the example of FIGS. 6A to 6C, the driver circuitry of the controller 600 includes an HS1 driver circuit 667, an HS2 driver circuit 674, an LS2 driver circuit 680, and an LS1 driver circuit 687. The HS1 driver circuit 667 has a first current input 668, a second current input 669, a control input 670, and the first control output 538. In operation, the HS1 driver circuit 667 is configured to: receive a pump voltage (V_{PUMP}) at the first current input 668; receive V_{CFLY+} at the fat the second current input 669; receive HS1_ON at the control input 670; and provide a drive signal (e.g., D̅₀) for HS1 at the first control output 538 responsive to HS1_ON, V_{PUMP}, and V_{CFLY+}. In some example embodiments, V_{PUMP} is higher than V_{CFLY+} and may vary in value. For example, V_{PUMP} may be less than V_{DD} during boot operations and then equal to V_{DD} once boot operations are complete.

The HS2 driver circuit 674 has a first current input 675, a control input 676, a second current input 677, and the second control output 540. In operation, the HS2 driver circuit 674 is configured to: receive V_{PUMP} at the first current input 675; receive HS2_ON at the control input 676; receive V_{SW} at the second current input 677; and provide a drive signal (e.g., D̅₁₈₀) for HS2 at the second control output 540 responsive to V_{PUMP}, V_{SW}, and HS2_ON. In some example embodiments, V_{PUMP} is higher than V_{CFLY+} and may vary in value. For example, V_{PUMP} may be less than V_{DD} during boot operations and then equal to V_{DD} once boot operations are complete.

The LS2 driver circuit 680 has a first current input 681, a control input 682, a second current input 683, and the third control output 542. In operation, the LS2 driver circuit 680 is configured to: receive V_{CFLY+} at the first current input 681; receive LS2_ON at the control input 682; receive V_{CFLY-} at the second current input 683; and provide a drive signal (e.g., D₁₈₀) for LS2 at the third control output 542 responsive to LS2_ON, V_{CFLY+}, and V_{CFLY-}.

The LS1 driver circuit 687 has a power input 688, a control input 689, the fourth control output 544, and a ground terminal 691. In operation, the LS1 driver circuit 687 is configured to: receive V_{DD} at the power input 688; receive LS1_ON at the control input 689; and provide a drive signal (e.g., D₀) for LS1 at the fourth control output 544 responsive to V_{DD} and LS1_ON.

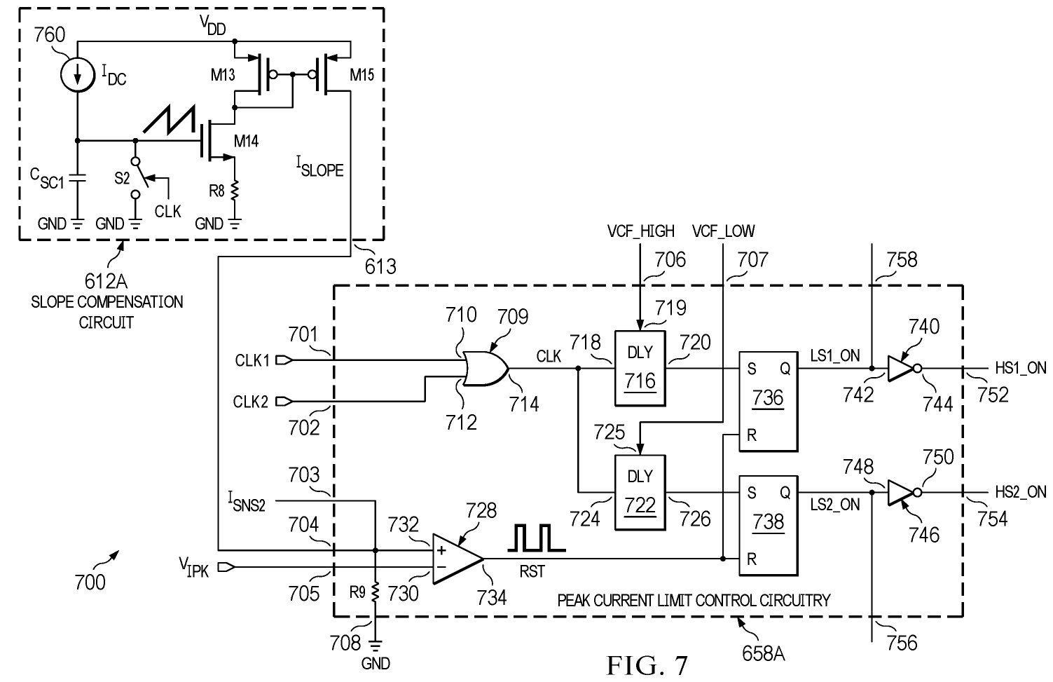

FIG. 7 is a schematic diagram 700 showing a slope compensation circuit 612A (an example of the second slope compensation circuit 612 in FIGS. 6A) and peak current limit control circuitry 658A (an example of the peak current limit control circuitry 658 in FIG. 6B) in accordance with an example embodiment. As shown, the slope compensation circuit 612A has the slope compensation output 613 and includes an I_{DC} source 760, capacitor C_{SC1}, switch S2, resistor R8, and transistors M13, M14, and M15 in the arrangement shown. A first side of the I_{DC} source 760 is coupled to a V_{DD} source. The second side of the I_{DC} source 760 is coupled to a first side of C_{SC1}, a first side of S2, and the control terminal of M14. The second sides of C_{SC1} and S2 are coupled to a ground terminal. The first current terminal of M13 is coupled to the V_{DD} source. The second current terminal of M13 is coupled to the first current terminal of M14 and the control terminals of M13 and M15. The second current terminal of M14 is coupled to a first side of R8. The second side of R8 is coupled to a ground terminal. The first current terminal of M15 is coupled to the V_{DD} source. The second current terminal of M15 is coupled to the slope compensation output 613. As shown, S2 is operated by a control signal (e.g., CLK). In operation, the slope compensation circuit 612A is configured to provide a slope compensation current (I_{SLOPE}) at the slope compensation output 613 responsive to I_{DC}, CLK, and the operations of S2, M13, M14, and M15.

In the example of FIG. 7, the peak current limit control circuitry 658A has a first clock input 701, a second clock input 702, a first control input 703, a second control input 704, a third control input 705, a fourth control input 706, a fifth control input 707, a first control output 752, a second control output 754, a third control output 756, a fourth control output 758, and a ground terminal 708. In some example embodiments: the first clock input 701 is coupled first clock source (e.g., part of the multi-mode control circuitry 642 in FIG. 6); the second clock input 702 is coupled to a second clock source (e.g., part of the multi-mode control circuitry 642 in FIG. 6); the first control input 703 is coupled to the eighth control input 652 of the multi-mode control circuitry 642 and receives I_{SNS2}; the second control input 704 is coupled to the ninth control input 653 of the multi-mode control circuitry 642 and receives I_{SLOPE}; the third control input 705 is coupled to the sixth control input 649 of the multi-mode control circuitry 642 and receives V_{IPK}; and the ground terminal 708 is coupled to the ground terminal 645 of the multi-mode control circuitry 642.

In some example embodiments, the fourth control input 706 is coupled to the fifth control input 648 of the multi-mode control circuitry 642 and receives a V_{CFLY} high signal (VCF_HIGH) responsive to V_{CFLY_ERROR}. In some example embodiments, the multi-mode control circuitry 642 includes a first comparator (not shown) configured to compare V_{CFLY_ERROR} at the fifth control input 648 with an upper V_{CFLY} error threshold. If V_{CFLY_ERROR} exceeds the upper V_{CFLY} error threshold, the first comparator provides VCF_HIGH to the fourth control input 706 as the first comparator output. The fifth control input 707 is coupled to the fifth control input 648 of the multi-mode control circuitry 642 and receives a V_{CFLY} low signal (VCF_LOW) responsive to V_{CFLY_ERROR}. In some example embodiments, the multi-mode control circuitry 642 includes a second comparator configured to compare V_{CFLY_ERROR} at the fifth control input 648 with a lower V_{CFLY} error threshold. If V_{CFLY_ERROR} drops below the lower V_{CFLY} error threshold, the second comparator provides VCF_LOW to the fifth control input 707 as the second comparator output.

In some example embodiments, the peak current limit control circuitry 658A includes an OR gate 709, a first delay circuit 716, a second delay circuit 722, a comparator 728, a resistor R9, a first SR latch 736, a second SR latch 738, a first inverter 740, and a second inverter 746 in the arrangement shown. The OR gate 709 has a first gate input 710, a second gate input 712, and a gate output 714. The first delay circuit 716 has a first control input 718, a second control input 719, and a delay output 720. The second delay circuit 722 has a first control input 724, a second control input 725, and a delay output 726. The comparator 728 has an inverting (“−”) input 730, a non-inverting (“+”) input 732, and a comparator output 734. The first SR latch 736 has an S input, an R input, and a Q output. The second SR latch 738 has an S input, an R input, and a Q output. The first inverter 740 has a first inverter input 742 and a first inverter output 744. The second inverter 746 has a second inverter input 748 and a second inverter output 750.

The first gate input 710 is coupled to the first clock input 701. The second gate input 712 is coupled to the second clock input 702. The gate output 714 is coupled to the first control input 718 of the first delay circuit 716 and the first control input 724 of the second delay circuit 722. The second control input 719 of the first delay circuit 716 is coupled to the fourth control input 706. The second control input 725 of the second delay circuit 722 is coupled to the fifth control input 707. The delay output 720 of the first delay circuit 716 is coupled to the S input of the first SR latch 736. The delay output 726 of the second delay circuit 722 is coupled to the S input of the second SR latch 738. The inverting (“−”) input 730 of the comparator 728 is coupled to the third control input 705. The non-inverting (“+”) input 732 of the comparator 728 is coupled to the first control input 703, the second control input 704, and a first side of R9. The second side of R9 is coupled to the ground terminal 708. The comparator output 734 of the comparator 728 is coupled to the R inputs of the first and second SR latches 736 and 738. In operation, the comparator 728 is configured to provide a reset signal (RST) at the comparator output 734 responsive to V_{IPK}, I_{SNS2}, and I_{SLOPE}. The Q output of the first SR latch 736 is coupled to the first inverter input 742 of the first inverter 740 and the fourth control output 758. The fourth control output 758 is coupled to the fourth control output 657 of the multi-mode control circuitry 642. The first inverter output 744 of the first inverter 740 is coupled to the first control output 752. The first control output 752 is coupled to the first control output 654 of the multi-mode control circuitry 642. The Q output of the second SR latch 738 is coupled to the second inverter input 748 of the second inverter 746 and the third control output 756. The third control output 756 is coupled to the third control output 656 of the multi-mode control circuitry 642. The second inverter output 750 of the second inverter 746 is coupled to the second control output 754. The second control output 754 is coupled to the second control output 655 of the multi-mode control circuitry 642.

In operation, the peak current limit control circuitry 658A is configured to: receive a first clock signal (CLK1) at the first clock input 701; receive a second clock signal (CLK2) at the second clock input 702; receive a high C_{FLY} voltage signal (VCF_HIGH) at the fourth control input 706; receive a low C_{FLY} voltage signal (VCF_LOW) at the fifth control input 707; receive I_{SNS2} at the first control input 703; receive I_{SLOPE} (an example of I_{SLOPE1} or I_{SLOPE2} in FIG. 6A, or a separate I_{SLOPE} relative to I_{SLOPE1} and I_{SLOPE2}) at the second control input 704; receive V_{IPK} at the third control input 705; provide HS1_ON at the first control output 752 responsive to CLK1, CLK2, VCF_HIGH, V_{IPK}, I_{SNS2}, and I_{SLOPE}, and the operations of the OR gate 709, the first delay circuit 716, the first SR latch 736, and the first inverter 740; provide LS1_ON at the fourth control output 758 responsive to CLK1, CLK2, VCF_HIGH, V_{IPK}, I_{SNS2}, and I_{SLOPE}, and the operations of the OR gate 709, the first delay circuit 716, and the first SR latch 736; provide HS2_ON at the second control output 754 responsive to CLK1, CLK2, VCF_LOW, V_{IPK} and I_{SNS2}, and I_{SLOPE}, and the operations of the OR gate 709, the second delay circuit 722, the second SR latch 738, and the second inverter 746; and provide LS2_ON at the third control output 756 responsive to CLK1, CLK2, VCF_LOW, V_{IPK}, I_{SNS2}, and I_{SLOPE}, and the operations of the OR gate 709, the second delay circuit 722, and the second SR latch 738. With the peak current limit control circuitry 658A, the peak current limit control options (e.g., 3-level control and 2-level control options) have a constant frequency and provide overcurrent protection for a boost power stage while maintaining C_{FLY} balanced at V_{OUT}/2.

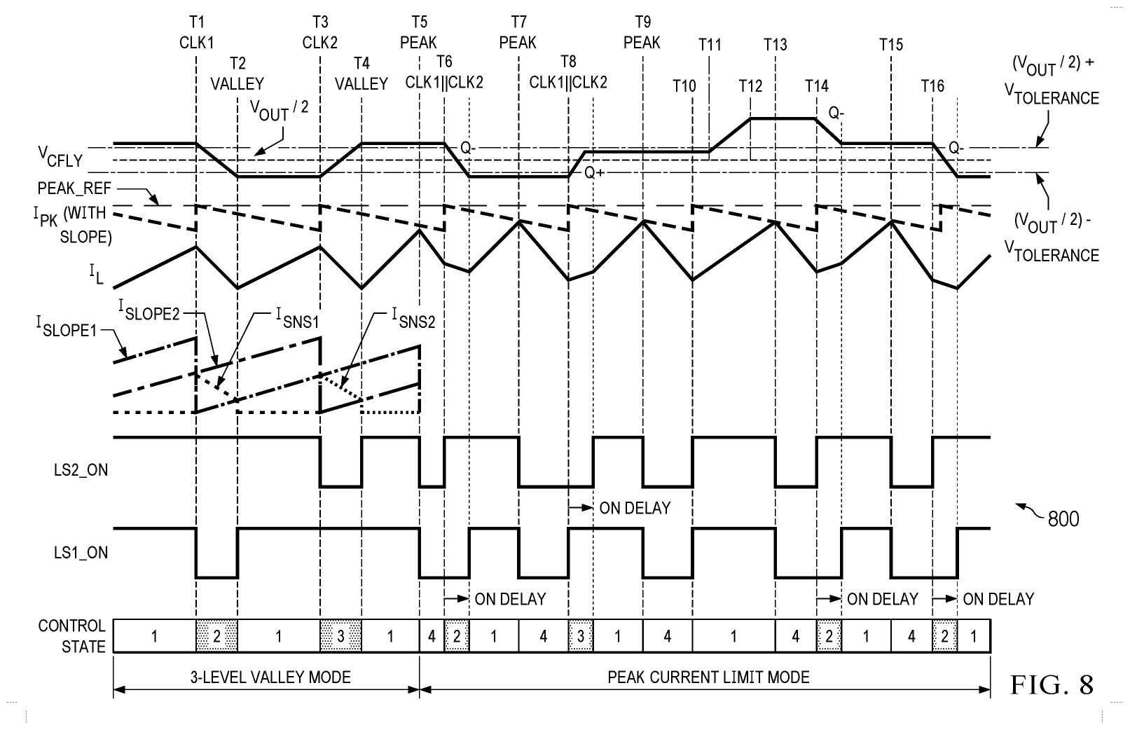

FIG. 8 is a timing diagram 800 showing signals and control states for a boost power stage (e.g., the boost power stage 502 of FIG. 5) based on the peak current limit control circuitry 658A of FIG. 7. In the timing diagram 800, signals for V_{CFLY}, a peak current (I_{PK}), I_{L}, I_{SLOPE1}, I_{SLOPE2}, I_{SNS1}, I_{SNS2}, LS2_ON, and LS1_ON are represented. In the timing diagram 800, the crossing points of I_{SLOPE1} and I_{SNS1} trigger the rising edge of LS1_ON. Also, the crossing points of I_{SLOPE2} and I_{SNS2} trigger the rising edge of LS2_ON. The timing diagram 800 also shows upper and lower V_{CFLY} thresholds and a peak current threshold (PEAK_REF). While not shown, HS1_ON is the inverse of LS1_ON, and HS2_ON is the inverse of LS2_ON.

As shown, the control states in the timing diagram are split into a 3-level valley control interval and a peak current limit control interval. During these intervals, the control state options include a low-side on phase (control state “1” in FIG. 8), a first intermediate phase (control state “3” in FIG. 8), a second intermediate phase (control state “2” in FIG. 8), and a high-side on phase (control state “4” in FIG. 8). In the low-side on phase (control state 1), LS1_ON is high, LS2_ON is high, HS1_ON is low, and HS2_ON is low. In the first intermediate phase (control state 3), LS1_ON is high, LS2_ON is low, HS1_ON is low, and HS2_ON is high. In the second intermediate phase (control state 2), LS1_ON is low, LS2_ON is high, HS1_ON is high, and HS2_ON is low. In the high-side phase on (control state 4), LS1_ON is low, LS2_ON is low, HS1_ON is high, and HS2_ON is high.

Initially, before time T1, the boost power stage is controlled using control state 1, resulting in I_{L} ramping up and V_{CFLY} being maintained. At time T1, CLK1 triggers the end of the control state 1. From time T1 to time T2, the boost power stage is controlled using control state 2, resulting in I_{L} and V_{CFLY} ramping down. At time T2, a current valley detection triggers the end of the control state 2. From time T2 to time T3, the boost power stage is controlled using control state 1, resulting in I_{L} ramping up and V_{CFLY} being maintained. At time T3, CLK2 triggers the end of the control state 1. From time T3 to time T4, the boost power stage is controlled using control state 3, resulting in resulting in I_{L} ramping down and V_{CFLY} ramping up. At time T4, a current valley detection triggers the end of the control state 3. From time T4 to time T5, the boost power stage is controlled using control state 1, resulting in resulting in I_{L} ramping up and V_{CFLY} being maintained.

At time T5, I_{L} reaching I_{PK} is detected, which transitions control of the boost power stage from the 3-level valley control interval to the peak current limit control interval. As shown in the timing diagram 800, I_{PK} is sloped relative to PEAK_REF. During the peak current limit mode after time T5, the slope of I_{PK} is based on I_{SLOPE} in FIG. 7. From time T5 to time T6, the boost power stage is controlled using control state 4, resulting in I_{L} ramping down and V_{CFLY} being maintained. At time T6, CLK1∥CLK2 triggers the end of the control state 4 and V_{CFLY} is detected as being above a target range. As a result, the boost power stage is controlled using control state 2 for a predetermined time (labeled “ON delay”), resulting in I_{L} and V_{CFLY} ramping down. After the predetermined time, the control state 2 ends and the boost power stage is controlled using control state 1, resulting in I_{L} ramping up and V_{CFLY} being maintained. At time T7, I_{L} reaching I_{PK} triggers a transition from control state 1 to control state 4. From time T7 to time T8, the boost power stage is controlled using control state 4, resulting in resulting in I_{L} ramping down and V_{CFLY} being maintained.

At time T8, CLK1∥CLK2 triggers the end of the control state 4 and V_{CFLY} is detected as being below the target range. As a result, the boost power stage is controlled using control state 3 for a predetermined time, resulting in I_{L} and V_{CFLY} ramping up. For control state 3, I_{L} ramps up when V_{CFLY}<V_{OUT}/2+a tolerance offset, and ramps down when V_{CFLY}>V_{OUT}/2+a tolerance offset.

After the predetermined time, the control state 3 ends and the boost power stage is controlled using control state 1, resulting in I_{L} ramping up and V_{CFLY} being maintained. At time T9, I_{L} reaching I_{PK} triggers a transition from control state 1 to control state 4. From time T9 to time T10, the boost power stage is controlled using control state 4, resulting in resulting in I_{L} ramping down and V_{CFLY} being maintained.

At time T10, CLK1∥CLK2 triggers the end of the control state 4 and V_{CFLY} is detected as being within the target range. From time T10 to time T11, the boost power stage is controlled using control state 1, resulting in I_{L} ramping up and V_{CFLY} being maintained. At time T11, V_{CFLY} begins to rise during the control state 1 until time T12. The increase in V_{CFLY} from T11 to T12 may be due to external sources and the response of the controller. From time T12 to time T13, V_{CFLY} is maintained. At time T13, I_{L} reaching I_{PK} triggers a transition from control state 1 to control state 4. From time T13 to time T14, the boost power stage is controlled using control state 4, resulting in resulting in I_{L} ramping down and V_{CFLY} being maintained.

At time T14, CLK1∥CLK2 triggers the end of the control state 4 and V_{CFLY} is detected as being above the target range. As a result, the boost power stage is controlled using control state 2 for a predetermined time, resulting in I_{L} ramping up and V_{CFLY} ramping down. After the predetermined time, the control state 2 ends and the boost power stage is controlled using control state 1, resulting in I_{L} ramping up and V_{CFLY} being maintained. At time T15, I_{L} reaching I_{PK} triggers a transition from control state 1 to control state 4. From time T15 to time T16, the boost power stage is controlled using control state 4, resulting in resulting in I_{L} ramping down and V_{CFLY} being maintained.

At time T16, CLK1∥CLK2 triggers the end of the control state 4 and V_{CFLY} is detected as being above the target range. As a result, the boost power stage is controlled using control state 2 for a predetermined time, resulting in I_{L} and V_{CFLY} ramping down. For control state 2, I_{L} ramps up when V_{CFLY}>V_{OUT}/2+a tolerance offset, and ramps down when V_{CFLY}<V_{OUT}/2+a tolerance offset.

After the predetermined time, the control state 2 ends and the boost power stage is controlled using control state 1, resulting in I_{L} ramping up and V_{CFLY} being maintained. With the peak current limit control circuitry 658A, the peak current limit control options (e.g., 3-level control and 2-level control options) during the peak current limit control interval have a constant frequency as shown in the timing diagram 800 and provide overcurrent protection for boost power stage components while maintaining C_{FLY} balanced at V_{OUT}/2.

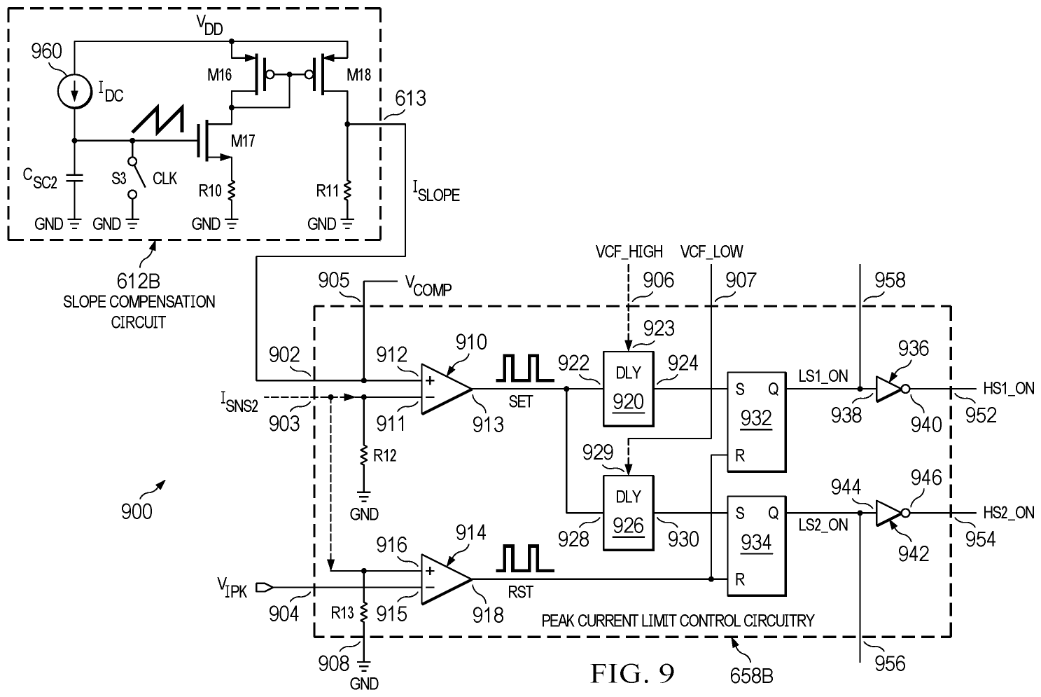

FIG. 9 is a schematic diagram 900 showing a slope compensation circuit 612B (an example of the second slope compensation circuit 612 in FIG. 6A) and peak current limit control circuitry 658B (an example of the peak current limit control circuitry 658 in FIG. 6B) in accordance with an example embodiment. As shown, the slope compensation circuit 612B has the slope compensation output 613 and includes an I_{DC} source 960, capacitor C_{SC2}, switch S3, resistors R10 and R11, and transistors M16, M17, and M18 in the arrangement shown. A first side of the I_{DC} source 960 is coupled to a V_{DD} source. The second side of the I_{DC} source 960 is coupled to a first side of C_{SC2}, a first side of S3, and the control terminal of M17. The second sides of C_{SC2} and S3 are coupled to a ground terminal. The first current terminal of M16 is coupled to the V_{DD} source. The second current terminal of M16 is coupled to the first current terminal of M17 and the control terminals of M16 and M18. The second current terminal of M17 is coupled to a first side of R10. The second side of R10 is coupled to a ground terminal. The first current terminal of M18 is coupled to the V_{DD} source. The second current terminal of M18 is coupled to the slope compensation output 613 and a first side of R11. The second side of R11 is coupled to a ground terminal. As shown, S3 is operated by a control signal (CLK). In operation, the slope compensation circuit 612B is configured to provide a slope compensation current (I_{SLOPE}) at the slope compensation output 613 responsive to I_{DC}, CLK, and the operations of S3, M16, M17, and M18.

In the example of FIG. 9, the peak current limit control circuitry 658B has a first control input 902, a second control input 903, a third control input 904, a fourth control input 905, a fifth control input 906, a sixth control input 907, a ground terminal 908, a first control output 952, a second control output 954, a third control output 956, a fourth control output 958. In some example embodiments: the first control input 902 is coupled to the ninth control input 653 of the multi-mode control circuitry 642 and receives I_{SLOPE}; the second control input 903 is coupled to the eighth control input 652 of the multi-mode control circuitry 642 and receives I_{SNS2}; the third control input 904 is coupled to sixth control input 649 of the multi-mode control circuitry 642 and receives V_{IPK}; the fourth control input 905 is coupled to the fourth control input 647 of the multi-mode control circuitry 642 and receives V_{COMP}; and the ground terminal 908 is coupled to the ground terminal 645 of the multi-mode control circuitry 642.

In some example embodiments, the fifth control input 906 is coupled to the fifth control input 648 of the multi-mode control circuitry 642 and receives a V_{CFLY} high signal (VCF_HIGH) responsive to V_{CFLY_ERROR}. In some example embodiments, the multi-mode control circuitry 642 includes a first comparator (not shown) configured to compare V_{CFLY_ERROR} at the fifth control input 648 with an upper V_{CFLY} error threshold. If V_{CFLY_ERROR} exceeds the upper V_{CFLY} error threshold, the first comparator provides VCF_HIGH to the fifth control input 906 as the first comparator output. The sixth control input 907 is coupled to the fifth control input 648 of the multi-mode control circuitry 642 and receives a V_{CFLY} low signal (VCF_LOW) responsive to V_{CFLY_ERROR}. In some example embodiments, the multi-mode control circuitry 642 includes a second comparator configured to compare V_{CFLY_ERROR} at the fifth control input 648 with a lower V_{CFLY} error threshold. If V_{CFLY_ERROR} drops below the lower V_{CFLY} error threshold, the second comparator provides VCF_LOW to the sixth control input 907 as the second comparator output.

In some example embodiments, the peak current limit control circuitry 642B includes a first comparator 910, a second comparator 914, resistors R12 and R13, a first delay circuit 920, a second delay circuit 926, a first SR latch 932, a second SR latch 934, a first inverter 936, and a second inverter 942 in the arrangement shown. The first comparator 910 has an inverting (“−”) input 911, a non-inverting (“+”) input 912, and a comparator output 913. The second comparator 914 has an inverting (“−”) input 915, a non-inverting (“+”) input 916, and a comparator output 918. The first delay circuit 920 has a first control input 922, a second control input 923, and a delay output 924. The second delay circuit 926 has a first control input 928, a second control input 929, and a delay output 930. The first SR latch 932 has an S input, an R input, and a Q output. The second SR latch 934 has an S input, an R input, and a Q output. The first inverter 936 has a first inverter input 938 and a first inverter output 940. The second inverter 942 has a second inverter input 944 and a second inverter output 946.

The inverting (“−”) input 911 of the first comparator 910 is coupled to the second control input 903 and a first side of R12. The second side of R12 is coupled to the ground terminal 908. The non-inverting (“+”) input 912 of the first comparator 910 is coupled to the first control input and the fourth control input 905. The comparator output 913 of the first comparator 910 is coupled to the first control input 922 of the first delay circuit 920 and the first control input 928 of the second delay circuit 926. The second control input 923 of the first delay circuit 920 is coupled to the fifth control input 906. The delay output 924 of the first delay circuit 920 is coupled to the S input of the first SR latch 932. The second control input 929 of the second delay circuit 926 is coupled to the sixth control input 907. The delay output 930 of the second delay circuit 926 is coupled to the S input of the second SR latch 934.

The inverting (“−”) input 915 of the second comparator 914 is coupled to the third control input 904. The non-inverting (“+”) input 916 of the second comparator 912 is coupled to the second control input 903 and a first side of R13. The second side of R13 is coupled to the ground terminal 908. The comparator output 918 of the second comparator 914 is coupled to the R inputs of the first and second SR latches 932 and 934. The Q output of the first SR latch 932 is coupled to the fourth control output 958 and the first inverter input 938 of the first inverter 936. The fourth control output 958 is coupled to the fourth control output 657 of the multi-mode control circuitry 642. The first inverter output 940 of the first inverter 936 is coupled to the first control output 952. The first control output 952 is coupled to the first control output 654 of the multi-mode control circuitry 642. The Q output of the second SR latch 934 is coupled to the third control output 956 and the second inverter input 944 of the second inverter 942. The third control output 956 is coupled to the third control output 656 of the multi-mode control circuitry 642. The second inverter output 946 of the second inverter 942 is coupled to the second control output 954. The second control output 954 is coupled to the second control output 655 of the multi-mode control circuitry 642.

In operation, the peak current limit control circuitry 658B is configured to: receive V_{IPK} at the third control input 904; receive a compensation voltage (labeled “V_{COMP}” in FIG. 9, where V_{COMP} may be V_{COMP1} or V_{COMP2} in FIG. 6A) at the fourth control input 905; receive I_{SNS2} at the second control input 903; receive I_{SLOPE} (an example of I_{SLOPE2} in FIG. 6A) at the first control input 902; receive VCF_HIGH at the fifth control input 906; receive VCF_LOW at the sixth control input 907; provide HS1_ON at the first control output 952 responsive to V_{IPK}, V_{COMP}, I_{SNS2}, I_{SLOPE}, and VCF_HIGH, and the operations of the first comparator 910, the second comparator 914, the first delay circuit 920, the first SR latch 932, and the first inverter 936; provide LS1_ON at the fourth control output 958 responsive to V_{IPK}, V_{COMP}, I_{SNS2}, I_{SLOPE}, and VCF_HIGH, and the operations of the first comparator 910, the second comparator 914, the first delay circuit 920, the first SR latch 932; provide HS2_ON at the second control output 954 responsive to V_{IPK}, V_{COMP}, I_{SNS2}, I_{SLOPE}, and VCF_LOW, and the operations of the first comparator 910, the second comparator 914, the second delay circuit 926, the second SR latch 934, and the second inverter 942; and provide LS2_ON at the third control output 956 responsive to V_{IPK}, V_{COMP}, I_{SNS2}, I_{SLOPE}, and VCF_HIGH, and the operations of the first comparator 910, the second comparator 914, the second delay circuit 926, and the second SR latch 934. With the peak current limit control circuitry 658B, the peak current limit control options (e.g., 3-level control and 2-level control options) have a varied frequency and provide overcurrent protection for boost power stage components while maintaining C_{FLY} balanced at V_{OUT}/2.

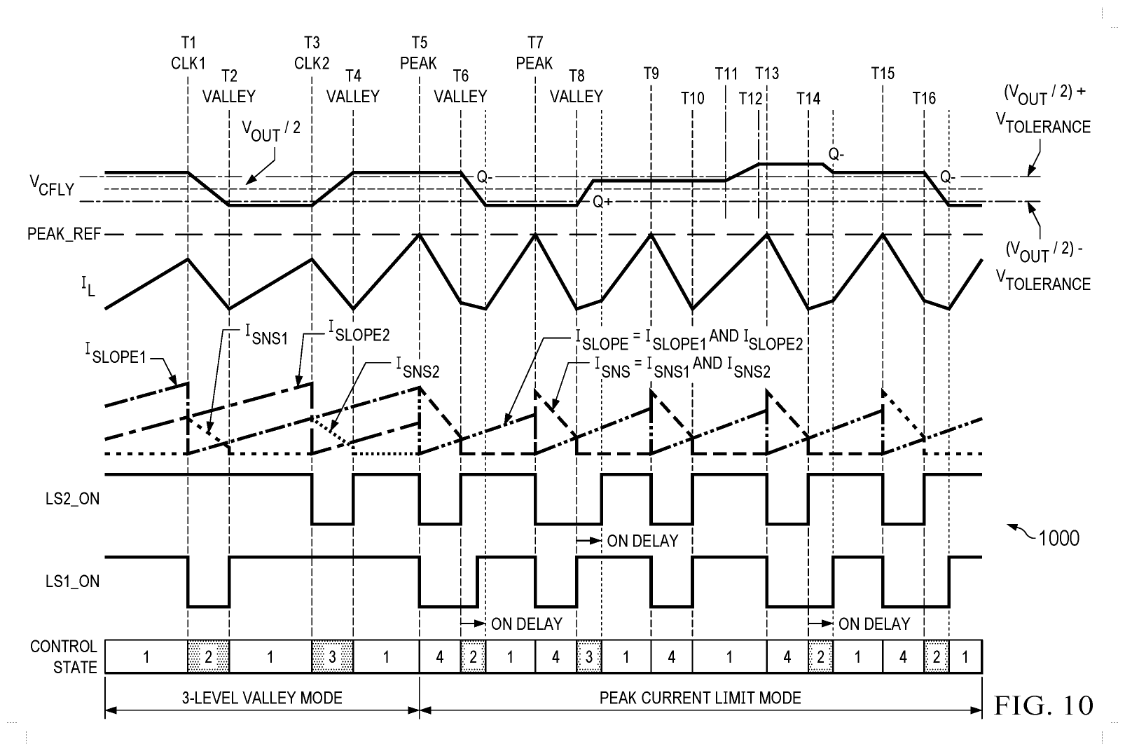

FIG. 10 is a timing diagram 1000 showing signals and control states for a boost power stage (e.g., the boost power stage 502 of FIG. 5) based on the peak current limit control circuitry 658B of FIG. 9. In the timing diagram 1000, signals for V_{CFLY}, I_{L}, I_{SLOPE1}, I_{SLOPE2}, I_{SNS1}, I_{SNS2}, LS2_ON, and LS1_ON are represented. In the timing diagram 1000, the crossing points of I_{SLOPE1} and I_{SNS1} before time T5 trigger the rising edge of LS1_ON. Also, the crossing points of I_{SLOPE2} and I_{SNS2} before time T5 trigger the rising edge of LS2_ON. After time T5, I_{SLOPE1} and I_{SLOPE2} may be merged to provide I_{SLOPE}. As another option, I_{SLOPE} may be generated without I_{SLOPE1} and/or I_{SLOPE2}. I_{SNS1} and I_{SNS2} are merged becoming an “I_{SNS}” signal. The timing diagram 1000 also shows upper and lower V_{CFLY} thresholds and a peak current threshold (PEAK_REF). While not shown, HS1_ON is the inverse of LS1_ON, and HS2_ON is the inverse of LS2_ON.

As shown, the control states in the timing diagram are split into a 3-level valley control interval and a peak current limit control interval. During these intervals, the control state options include a low-side on phase (control state “1” in FIG. 10), a first intermediate phase (control state “3” in FIG. 10), a second intermediate phase (control state “2” in FIG. 10), and a high-side on phase (control state “4” in FIG. 10). In the low-side on phase (control state 1), LS1_ON is high, LS2_ON is high, HS1_ON is low, and HS2_ON is low. In the first intermediate phase (control state 3), LS1_ON is high, LS2_ON is low, HS1_ON is low, and HS2_ON is high. In the second intermediate phase (control state 2), LS1_ON is low, LS2_ON is high, HS1_ON is high, and HS2_ON is low. In the high-side phase on (control state 4), LS1_ON is low, LS2_ON is low, HS1_ON is high, and HS2_ON is high.

Initially, before time T1, the boost power stage is controlled using control state 1, resulting in I_{L} ramping up and V_{CFLY} being maintained. At time T1, CLK1 triggers the end of the control state 1. From time T1 to time T2, the boost power stage is controlled using control state 2, resulting in I_{L} and V_{CFLY} ramping down. At time T2, a current valley detection triggers the end of the control state 2. From time T2 to time T3, the boost power stage is controlled using control state 1, resulting in I_{L} ramping up and V_{CFLY} being maintained. At time T3, CLK2 triggers the end of the control state 1. From time T3 to time T4, the boost power stage is controlled using control state 3, resulting in resulting in I_{L} ramping down and V_{CFLY} ramping up. At time T4, a current valley detection triggers the end of the control state 3. From time T4 to time T5, the boost power stage is controlled using control state 1, resulting in resulting in I_{L} ramping up and V_{CFLY} being maintained.

At time T5, I_{L} reaching PEAK_REF is detected, which transitions control of the boost power stage from the 3-level valley control interval to the peak current limit control interval. From time T5 to time T6, the boost power stage is controlled using control state 4, resulting in I_{L} ramping down and V_{CFLY} being maintained. At time T6, I_{L} is detected as being below a valley threshold triggering the end of the control state 4. Also, V_{CFLY} is detected as being above a target range at time T6. As a result, the boost power stage is controlled using control state 2 for a predetermined time (labeled “ON delay”), resulting in I_{L} and V_{CFLY} ramping down. After the predetermined time, the control state 2 ends and the boost power stage is controlled using control state 1, resulting in I_{L} ramping up and V_{CFLY} being maintained. At time T7, I_{L} reaching PEAK_REF triggers a transition from control state 1 to control state 4. From time T7 to time T8, the boost power stage is controlled using control state 4, resulting in resulting in I_{L} ramping down and V_{CFLY} being maintained.

At time T8, I_{L} is detected as being below a valley threshold triggering the end of the control state 4. Also, V_{CFLY} is detected as being below the target range at time T8. As a result, the boost power stage is controlled using control state 3 for a predetermined time, resulting in I_{L} and V_{CFLY} ramping up. For control state 3, I_{L} ramps up when V_{CFLY}<V_{OUT}/2+a tolerance offset, and ramps down when V_{CFLY}>V_{OUT}/2+a tolerance offset.

After the predetermined time, the control state 3 ends and the boost power stage is controlled using control state 1, resulting in I_{L} ramping up and V_{CFLY} being maintained. At time T9, I_{L} reaching PEAK_REF triggers a transition from control state 1 to control state 4. From time T9 to time T10, the boost power stage is controlled using control state 4, resulting in resulting in I_{L} ramping down and V_{CFLY} being maintained.

At time T10, I_{L} is detected as being below a valley threshold triggering the end of the control state 4. Also, V_{CFLY} is detected as being within the target range at time T10. Accordingly, from time T10 to time T11, the boost power stage is controlled using control state 1, resulting in I_{L} ramping up and V_{CFLY} being maintained. At time T11, V_{CFLY} begins to rise during the control state 1 until time T12. The increase in V_{CFLY} from T11 to T12 may be due to external sources (e.g., changes in the load current) and the response of the controller. From time T12 to time T13, V_{CFLY} is maintained. At time T13, I_{L} reaching PEAK_REF triggers a transition from control state 1 to control state 4. From time T13 to time T14, the boost power stage is controlled using control state 4, resulting in resulting in I_{L} ramping down and V_{CFLY} being maintained.

At time T14, I_{L} is detected as being below a valley threshold triggering the end of the control state 4. Also, V_{CFLY} is detected as being above the target range at time T14. As a result, the boost power stage is controlled using control state 2 for a predetermined time, resulting in I_{L} ramping up and V_{CFLY} ramping down. After the predetermined time, the control state 2 ends and the boost power stage is controlled using control state 1, resulting in I_{L} ramping up and V_{CFLY} being maintained. At time T15, I_{L} reaching PEAK_REF triggers a transition from control state 1 to control state 4. From time T15 to time T16, the boost power stage is controlled using control state 4, resulting in resulting in I_{L} ramping down and V_{CFLY} being maintained.

At time T16, I_{L} is detected as being below a valley threshold triggering the end of the control state 4. Also, V_{CFLY} is detected as being above the target range at time T16. As a result, the boost power stage is controlled using control state 2 for a predetermined time, resulting in I_{L} and V_{CFLY} ramping down. For control state 2, I_{L} ramps up when V_{CFLY}>V_{OUT}/2+a tolerance offset, and ramps down when V_{CFLY}<V_{OUT}/2+a tolerance offset.

After the predetermined time, the control state 2 ends and the boost power stage is controlled using control state 1, resulting in I_{L} ramping up and V_{CFLY} being maintained. With the peak current limit control circuitry 658B, the peak current limit control options (e.g., 3-level control and 2-level control options) during the peak current limit control interval have a varied frequency as shown in the timing diagram 1000 and provide overcurrent protection for a boost power stage while maintaining C_{FLY} balanced at V_{OUT}/2.

Comparing the constant frequency peak current limit control option (see e.g., FIGS. 7 and 8) and the varied frequency peak current limit control option (see e.g., FIGS. 9 and 10), the following differences are noted: 1) the constant frequency peak current limit control option uses CLK1∥CLK2 to trigger some of the control state transitions and the V_{CFLY} adjustments while the varied frequency peak current limit control option uses I_{L} current valley detection for the same purpose; and 2) the constant frequency peak current limit control option needs a slope compensation at the input of the current peak comparator while the varied frequency peak current limit control option needs a slope compensation at input of the current valley comparator. As a result, the constant frequency peak current limit control option enables constant-frequency switching operations independent from voltage and load while the varied frequency peak current limit control option enables control of both current peak and valley.

The peak current limit control options described herein provide peak current limit control as needed with proper V_{CFLY} feedback (high flag/low flag) in the control loop. In some example embodiments, the peak current limit control options: 1) ensure full-load startup and current peak limit protection for a multi-level converter; 2) ensure V_{CFLY} balance during normal operations and current peak limit operations, leading to transistor voltages within a safe range and system robustness; 3) ensure smooth transitions between normal operations and current peak limit operations; 4) use a constant frequency switching topology or a varied frequency switching topology; 5) determine the variation magnitude of V_{CFLY} without fundamental frequency due to the intrinsic hysteresis feature; and 6) can be extended to different multi-level topologies (buck/boost/buck-boost, etc.) and different modes of operation (normal operation/current peak limit operation/light load operation, etc.).

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Also, in this description, the recitation “based on” means “based at least in part on.” Therefore, if X is based on Y, then X may be a function of Y and any number of other factors.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal”, “node”, “interconnection”, “pin” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

While the use of particular transistors is described herein, other transistors (or equivalent devices) may be used instead with little or no change to the remaining circuitry. For example, a field effect transistor (“FET”) (such as an n-channel FET (NFET) or a p-channel FET (PFET)), a bipolar junction transistor (BJT—e.g., NPN transistor or PNP transistor), an insulated gate bipolar transistor (IGBT), and/or a junction field effect transistor (JFET) may be used in place of or in conjunction with the devices described herein. The transistors may be depletion mode devices, drain-extended devices, enhancement mode devices, natural transistors or other types of device structure transistors. Furthermore, the devices may be implemented in/over a silicon substrate (Si), a silicon carbide substrate (SiC), a gallium nitride substrate (GaN) or a gallium arsenide substrate (GaAs).

References may be made in the claims to a transistor's control input and its current terminals. In the context of a FET, the control input is the gate, and the current terminals are the drain and source. In the context of a BJT, the control input is the base, and the current terminals are the collector and emitter.

References herein to a FET being “ON” means that the conduction channel of the FET is present and drain current may flow through the FET. References herein to a FET being “OFF” means that the conduction channel is not present so drain current does not flow through the FET. An “OFF” FET, however, may have current flowing through the transistor's body-diode.

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/−10 percent of that parameter or, if the parameter is zero, a reasonable range of values around zero.

Modifications are possible in the described embodiments, and other embodiments are possible, within the scope of the claims.

What is claimed is:

1. A boost converter control method comprising:
obtaining a peak current reference signal;
obtaining a current sense signal;
obtaining a flying capacitor (C_{FLY}) voltage error feedback signal; and
providing switch control signals during a peak current limit mode responsive to the peak current reference signal, the current sense signal, and the C_{FLY} voltage error feedback signal.

2. The boost converter control method of claim 1, further comprising:
obtaining a current slope signal; and
providing switch control signals during the peak current limit mode responsive to the peak current reference signal, the current sense signal, the C_{FLY} voltage error feedback signal, and the current slope signal.

3. The boost converter control method of claim 2, further comprising:
obtaining a first clock signal;
obtaining a second clock signal; and
providing switch control signals during the peak current limit mode responsive to the peak current reference signal, the current sense signal, the C_{FLY} voltage error feedback signal, the current slope signal, the first clock signal, and the second clock signal.

4. The boost converter control method of claim 3, further comprising triggering a C_{FLY} voltage correction based on the first clock signal, the second clock signal, and the C_{FLY} voltage error feedback signal.

5. The boost converter control method of claim 2, further comprising:
obtaining a voltage compensation signal; and
providing switch control signals during the peak current limit mode responsive to the peak current reference signal, the current sense signal, the C_{FLY} voltage error feedback signal, the current slope signal, and the voltage compensation signal.

6. The boost converter control method of claim 5, further comprising triggering a C_{FLY} voltage correction based on the current sense signal, the current slope signal, the voltage compensation signal, and the C_{FLY} voltage error feedback signal.

7. A boost converter controller comprising:
flying capacitor (C_{FLY}) voltage management circuitry having a first control output and first and second sense inputs, the C_{FLY} voltage management circuitry is configured to provide a C_{FLY} voltage error feedback signal at the first control output responsive to a positive terminal C_{FLY} voltage received at the first sense input and a negative terminal C_{FLY} voltage at the second sense input; and
multi-mode control circuitry having a first control input, a second control input, a third control input, a second control output, a third control output, a fourth control output, and a fifth control output, the first control input coupled to the first control output, and the multi-mode control circuitry configured to:
receive the C_{FLY} voltage error feedback signal at the first control input;
receive a current sense signal at the second control input;
receive a peak current reference signal at the third control input; and
in a peak current limit mode, provide switch control signals at the second control output, the third control output, the fourth control output, and the fifth control output responsive to the peak current reference signal, the current sense signal, and the C_{FLY} voltage error feedback signal.

8. The boost converter controller of claim 7, further comprising valley current sense circuit having a power input, a fourth control input, and a sense output, the valley current sense circuit configured to:
receive a power supply voltage at the power input;
receive a first high-side switch control signal at the fourth control input; and
provide a valley current sense signal at the sense output responsive to the first high-side switch control signal,
wherein the multi-mode control circuitry is configured to provide switch control signals at the second control output, the third control output, the fourth control output, and the fifth control output responsive to the valley current sense signal.

9. The boost converter controller of claim 8, wherein the valley current sense circuit is a first valley current sense circuit, the sense output is a first sense output, the valley current sense signal is a first valley current sense signal, and the boost converter controller further comprises a second valley current sense circuit having a current input, a fifth control input, and a second sense output, the second valley current sense circuit configured to:
receive a current at the current input;
receive a switch control signal at the fifth control input; and
provide a second valley current sense signal at the sense output responsive to the switch control signal and a voltage across C_{FLY},
wherein the multi-mode control circuitry is configured to provide switch control signals at the second control output, the third control output, the fourth control output, and the fifth control output responsive to the second valley current sense signal.

10. The boost converter controller of claim 9, wherein the C_{FLY} voltage management circuitry includes a sixth control output, the C_{FLY} voltage management circuitry configured to provide the switch control signal at the sixth control output.

11. The boost converter controller of claim 7, further comprising a peak current sense circuit having a power input, a fourth control input, and a sense output, the peak current sense circuit configured to:
receive a power supply voltage at the power input;
receive a first low-side switch control signal at the fourth control input; and
provide the current sense signal at the sense output responsive to the first low-side switch control signal.

12. The boost converter controller of claim 7, wherein the multi-mode control circuitry includes peak current limit control circuitry that includes:
a comparator having an inverting input, a non-inverting input and a comparator output, the inverting input coupled to the third control input, the non-inverting input coupled to the second control input;
a first SR latch having a first S input, a first R input, and a first Q output, the first R input coupled to the comparator output, the first Q output coupled to the fourth control output;
a second SR latch having a second S input, a second R input, and a second Q output, the second R input coupled to the comparator output, the second Q output coupled to the third control output;
a first inverter having a first inverter input and a first inverter output, the first inverter input coupled to the first Q output, and the first inverter output coupled to the first control output; and
a second inverter having a second inverter input and a second inverter output, the second inverter input coupled to the second Q output, and the second inverter output coupled to the second control output.

13. The boost converter controller of claim 12, wherein the peak current limit control circuitry has a fourth control input and first and second clock inputs, the peak current limit control circuitry configured to:
receive a current slope signal at the fourth control input;
receive a first clock signal at the first clock input;
receive a second clock signal at the second clock input; and
provide switch control signals at the second control output, the third control output, the fourth control output, and the fifth control output responsive to the peak current reference signal, the current sense signal, the C_{FLY} voltage error feedback signal, the current slope signal, the first clock signal, and the second clock signal.

14. The boost converter controller of claim 13, wherein the non-inverting input of the comparator is coupled to the fourth control input, and the peak current limit control circuitry includes:
an OR gate having a gate output and first and second gate inputs, the first gate input coupled to the first clock input, and the second gate input coupled to the second clock input;
a first delay circuit having a fifth control input, a sixth control input, and a first delay output, the fifth control input coupled to the gate output, the sixth control input coupled to the first control input, and the first delay output coupled to the first S input; and
a second delay circuit having a seventh control input, an eighth control input, and a second delay output, the seventh control input coupled to the gate output, the eighth control input coupled to the first control input, and the second delay output coupled to the second S input.

15. The boost converter controller of claim 12, wherein the peak current limit control circuitry has a fourth control input and a fifth control input, the peak current limit control circuitry configured to:
receive a current slope signal at the fourth control input;
receive a voltage compensation signal at the fifth control input; and
provide switch control signals at the second control output, the third control output, the fourth control output, and the fifth control output responsive to the peak current reference signal, the current sense signal, the C_{FLY} voltage error feedback signal, the current slope signal, and the voltage compensation signal.

16. The boost converter controller of claim 15, wherein the comparator is a first comparator, and the peak current limit control circuitry includes:
a second comparator having an inverting input, a non-inverting input and a comparator output, the inverting input of the second comparator coupled to the second control input, and the non-inverting input of the second comparator coupled to the fourth and fifth control inputs;
a first delay circuit having a sixth control input, a seventh control input, and a first delay output, the sixth control input coupled to the comparator output of the second comparator, the seventh control input coupled to first control input, and the first delay output coupled to the first S input; and
a second delay circuit having an eighth control input, a ninth control input, and a second delay output, the eighth control input coupled to the comparator output of the second comparator, the ninth control input coupled to first control input, and the second delay output coupled to the second S input.

17. A system comprising:
a multi-level boost converter power stage configured to provide an output voltage responsive to an input voltage, a flying capacitor (C_{FLY}) voltage level, and operation of a set of switches; and
a controller coupled to the multi-level boost converter power stage and configured to operate the set of switches using a multi-level valley mode and a peak current limit mode, the peak current limit mode responsive to a peak current reference signal, a current sense signal, a current slope signal, and a C_{FLY} voltage error feedback signal.

18. The system of claim 17, wherein the controller is configured to operate the multi-level boost converter power stage without intermediate phase states during the peak current limit mode responsive to the C_{FLY} voltage level being within a target range.

19. The system of claim 18, wherein the controller is configured to operate the multi-level boost converter power stage using intermediate states during the peak current limit mode responsive to the C_{FLY} voltage level being outside a target range.

20. The system of claim 17, wherein the controller is configured to apply a C_{FLY} voltage correction during the peak current limit mode responsive to a first clock signal, a second clock signal, and the C_{FLY} voltage error feedback signal.

21. The system of claim 17, wherein the controller is configured to apply a C_{FLY} voltage correction during the peak current limit mode responsive to a voltage compensation signal, the current sense signal, the current slope signal, and the C_{FLY} voltage error feedback signal.
